(19) United States
(12) Patent Application Publication
(10) Pub. No.: US 2012/0083268 A1
(43) Pub. Date: Apr. 5, 2012

(54) Method of Enhancing Public Land Mobile Network Search and Related Communication Device

(76) Inventors: Hsing-Yu Lung, Taoyuan County (TW); Chien-Jen Huang, Taoyuan County (TW)

(21) Appl. No.: 13/080,654

(22) Filed: Apr. 5, 2011

Related U.S. Application Data
(60) Provisional application No. 61/321,145, filed on Apr. 6, 2010.

(51) Int. Cl. H04W 48/18

(52) U.S. Cl. 455/434

(57) ABSTRACT

A method of enhancing public land mobile network (PLMN) search for a mobile device in a wireless communication system is disclosed. The method comprises deriving a mobile country code (MCC) for identifying a visited country when the mobile device is switched on, powered up, into flight mode off, or coming back from no service area, and performing the PLMN search excluding for at least a PLMN, whose MCC is not the same as the derived MCC, according to a PLMN search list stored in the mobile device.

### CROSS REFERENCE TO RELATED APPLICATIONS

This application claims the benefit of U.S. Provisional Application No. 61/321,145, filed on Apr. 6, 2010 and entitled “Method to fasten the network search in the international roaming scenario”, the contents of which are incorporated herein in their entirety.

### BACKGROUND OF THE INVENTION

1. Field of the Invention

The application relates to a method utilized in a wireless communication system and a communication device thereof, and more particularly, to a method of enhancing public land mobile network search in a wireless communication system and a related communication device.

2. Description of the Prior Art

A network (e.g. Global System for Mobile communications (GSM), Long Term Evolution (LTE), or Universal Mobile Telecommunications System (UMTS)) run by one operator in one country is known as a Public Land Mobile Network (PLMN). The PLMN consists of a Mobile Network Code (MNC) and Mobile Country Code (MCC) pair. Therefore, a mobile station (MS), also referred as a user equipment (UE), can identify a visited country and a network provider according to the MCC of the PLMN and the MNC of the PLMN respectively. The UE attempts to make contact with the PLMN when the UE is switched on (i.e. power up, flight mode off, or come back from no service area), and searches for a suitable cell of the PLMN to camp on, so as to obtain services provided by the cell. For abovementioned purpose, the UE performs a PLMN selection to find a PLMN contact. There are two modes for the PLMN selection:
i) Automatic mode: This mode utilizes a list of PLMNs in priority order. The highest priority PLMN which is available and allowable is selected;
ii) Manual mode: Here the MS indicates to the user which PLMNs are available.

As to the automatic selection mode, the UE first searches for a registered Public Land Mobile Network (RPLMN). If the RPLMN is not found, UE then searches for available networks one by one until success, in the following order: (1) home PLMN (HPLMN): a PLMN where the MCC and MNC of the PLMN match the MCC and MNC of the International Mobile Subscriber Identify (IMSI) in a Subscriber Identity Module (SIM) of the UE; (2) PPLMN: a PLMN stored in a PLMN selector (i.e. “User Controlled PLMN Selector with Access Technology” or “Operator Controlled PLMN Selector with Access Technology” data field in the SIM of the UE); (3) any PLMN with a received signal level above a predetermined value, in random order; (4) other PLMNs, in the descending order of signal quality.

Based on the abovementioned description, the applicant noticed a problem related to the PLMN search in an international roaming (e.g. the UE in a location that is different from the home location, and thereby the home network (i.e. HPLMN) is different). When the UE is switched on, powered up, into flight mode off, or coming back from no service area, the UE firstly searches for RPLMN, HPLMN, PPLMN, and then searches for a PLMN with signal quality (e.g. by signal strength) if no RPLMN, HPLMN, and PPLMN is found. However, the UE complied with the PLMN search list wastes a long time to search for the RPLMN, HPLMN, and PPLMN during roaming, and cannot find any since the UE travels outside a geographical coverage area of the HPLMN, the HPLMN is equivalent to the RPLMN generally, and there is no roaming agreement between the network operators. Thus, a huge amount of latency for unnecessary PLMN search occurs. Moreover, since no service can be provided to the UE during the PLMN search, the UE spends more time to obtain the service.

Note that, the abovementioned situation may occur in UMTS, GPRS, GSM and LTE system since the UE supporting these radio access technologies (RATs) complied with similar PLMN selection mechanism.

### SUMMARY OF THE INVENTION

The application discloses a method of enhancing public land mobile network (PLMN) search in a wireless communication system and a related communication device in order to solve the abovementioned problems.

A method of enhancing public land mobile network (PLMN) search for a mobile device in a wireless communication system is disclosed. The method comprises deriving a mobile country code (MCC) for identifying a visited country when the mobile device is switched on, powered up, into flight mode off, or coming back from no service area, and performing the PLMN search excluding for at least a PLMN, whose MCC is not the same as the derived MCC, according to a PLMN search list stored in the mobile device.

A mobile device of a wireless communication system for enhancing public land mobile network (PLMN) search is disclosed. The mobile device comprises means for deriving a mobile country code (MCC) for identifying a visited country when the mobile device is switched on, powered up, into flight mode off, or coming back from no service area, and means for performing the PLMN search excluding for at least a PLMN, whose MCC is not the same as the derived MCC, according to a PLMN search list stored in the mobile device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an exemplary wireless communication system.

FIG. 2 illustrates a schematic diagram of an exemplary communication device.

FIG. 3 is a flowchart of an exemplary process.

FIG. 4 is a flowchart of an exemplary PLMN selection procedure.

FIG. 5 is a flowchart diagram according to FIG. 4.

FIG. 6 is a flowchart diagram of a mobile country code (MCC) check procedure.

### DETAILED DESCRIPTION

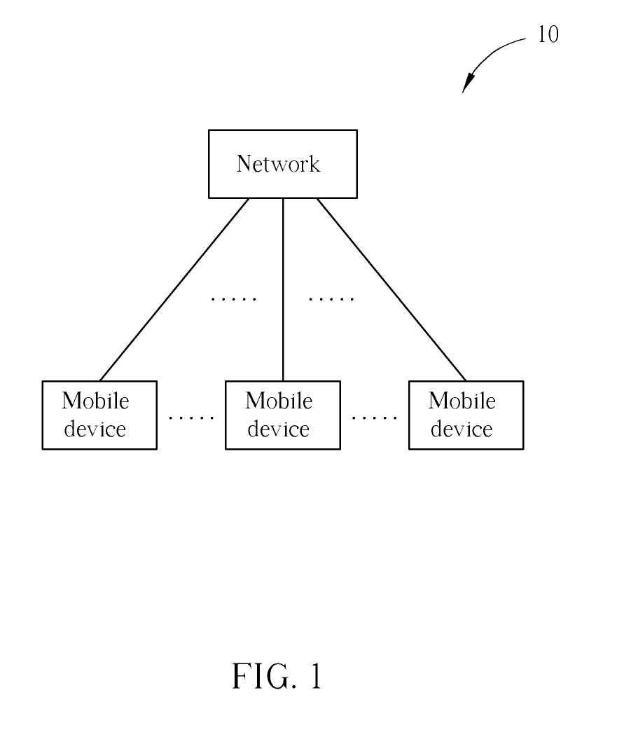

Please refer to FIG. 1, which illustrates a schematic diagram of a wireless communication system 10 according to an example. Briefly, the wireless communication system 10 is composed of a network and a plurality of mobile devices. The wireless communication system 10 can be a Global System for Mobile communications (GSM), Long Term Evolution (LTE) system, Universal Mobile Telecommunications System (UMTS), or any other similar network system. In the UMTS system, the network can be referred as a Universal Terrestrial Radio Access Network (UTRAN) comprising a plurality of base stations (Node Bs) and Radio Network Controllers (RNCs), whereas the mobile devices are referred as to user equipments (UEs). The UEs can be devices such as mobile phones, computer systems, etc. This terminology will be used throughout the application for ease of reference. However, this should not be construed as limiting the disclosure to any one particular type of network. In some examples, the network and the UE may be seen as a transmitter or receiver according to transmission direction, e.g., for uplink (UL), the UE is the transmitter and the network is the receiver, and for downlink (DL), the network is the transmitter and the UE is the receiver.

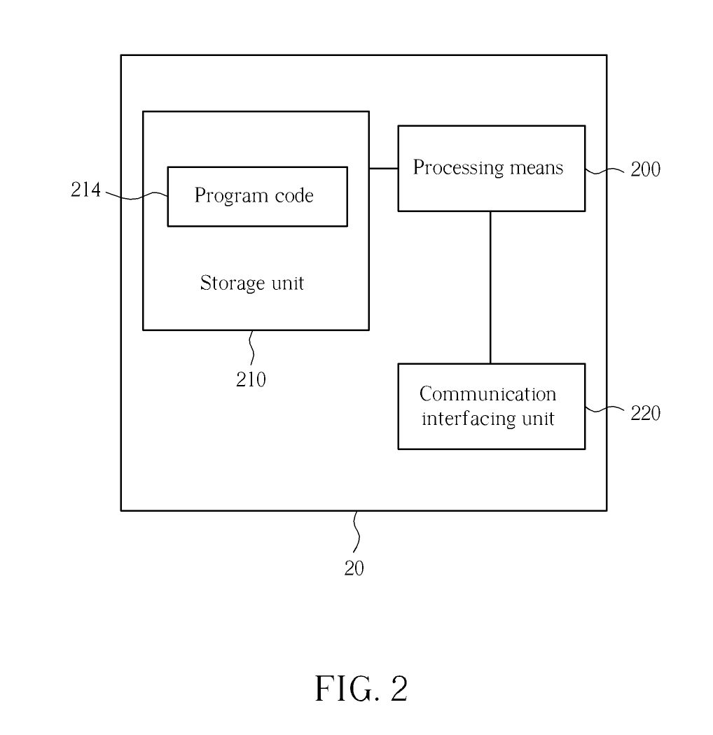

FIG. 2 illustrates a schematic diagram of an exemplary communication device 20. The communication device 20 can be the mobile device or the network shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that can store program code 214, for access by the processing means 200. Examples of the storage unit 210 include but are not limited to a subscriber identity module (SIM), read-only memory (ROM), flash memory, random-access memory (RAM), CD-ROMs, magnetic tape, hard disk, and optical data storage device. The communication interfacing unit 220 is preferably a radio transceiver and can exchange wireless signals with the network according to processing results of the processing means 200.

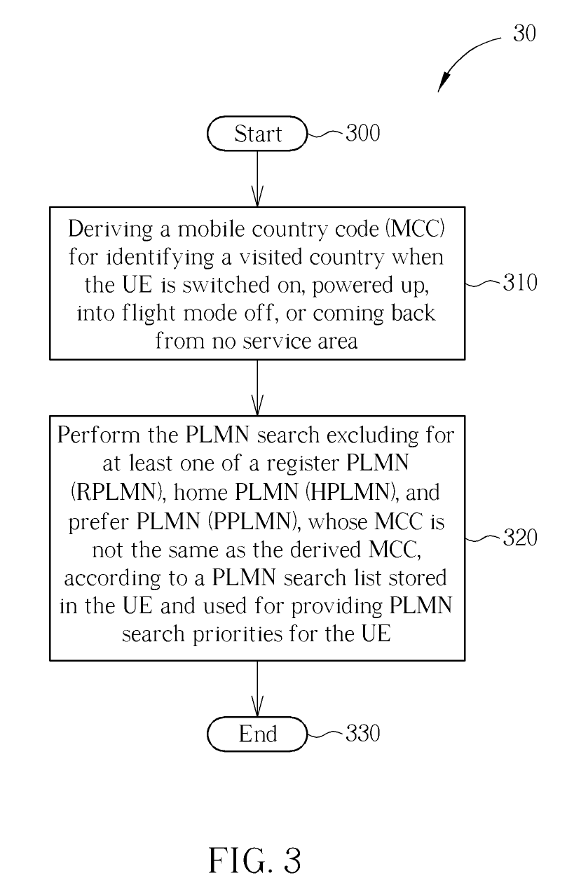

Please refer to FIG. 3, which illustrates a flowchart of an exemplary process 30. The process 30 is utilized in an UE (as the mobile device of FIG. 1) for enhancing public land mobile network (PLMN) search procedure. The process 30 can be compiled into the program code 214 and includes the following steps:

Step 300: Start.

Step 310: Deriving a mobile country code (MCC) for identifying a visited country when the UE is switched on, powered up, into flight mode off, or coming back from no service area.

Step 320: Perform the PLMN search excluding for at least one of a register PLMN (RPLMN), home PLMN (HPLMN), and prefer PLMN (PPLMN), whose MCC is not the same as the derived MCC, according to a PLMN search list stored in the UE and used for providing PLMN search priorities for the UE.

Step 330: End.

According to the process 30, the UE derives its located country information (namely the MCC) upon power up, flight mode off and come back from no service area, and does not perform the PLMN search for the RPLMN, HPLMN, and/or PPLMN if MCC(s) of the RPLMN, HPLMN, and/or PPLMN are/is different with the derived MCC. That is, the UE skips to search the RPLMN, HPLMN and/or PPLMN in the PLMN search list if the MCC(s) of the RPLMN, HPLMN, and/or PPLMN are/is not the same as the derived MCC, thereby reducing latency due to unnecessary PLMN search. In addition, the UE directly performs the PLMN search by any PLMN search in the PLMN search list (i.e. the UE searches for a PLMN with signal quality) when the MCCs of the RPLMN, HPLMN and PPLMN are all different with the derived MCC.

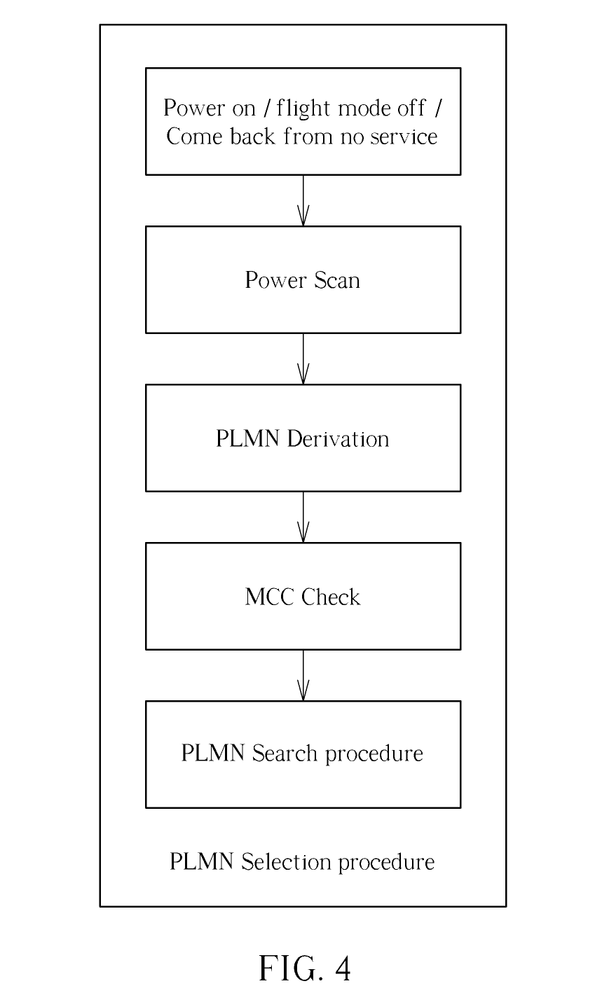

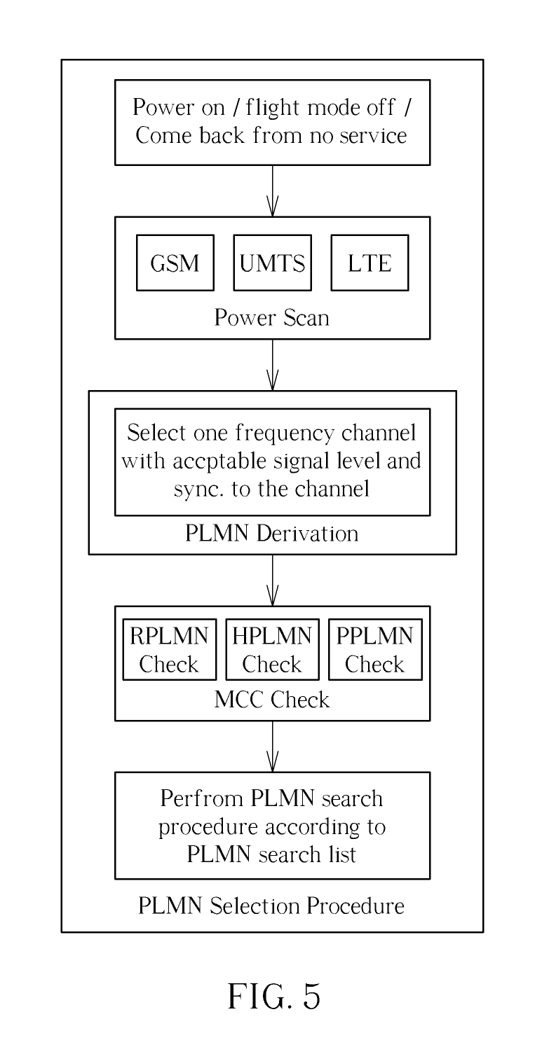

Take an example based on the process 30. Please refer to FIG. 4, which is a flowchart of an exemplary PLMN selection procedure utilized in the UE. When an UE is switched on (i.e. power up, flight mode off or come back from no service area), the UE goes over the following three steps: power scan, PLMN derivation, and MCC check, before performing the PLMN search according to the PLMN search list stored in the UE. For clearly operation, please refer to FIG. 5. The UE performs the power scan over a range of frequency based on one or more radio access technologies (RATs) (e.g. LTE, UMTS, GSM/GPRS) supported in the UE, in order to derive a PLMN. In other words, the UE scans all RF channels in LTE, UMTS, and GSM/GPRS bands for PLMN derivation. The UE acquires at least a frequency channel where the received signal level over the frequency channel is larger than a threshold. Note that, a value of the threshold is defined for implementation purpose where the higher the threshold the fewer frequency channels can be derived. For the PLMN derivation, the UE selects at least a frequency channel, and then performs the synchronization procedure including a frequency synchronization, a frame synchronization and a slot synchronization over the selected frequency channel(s). After that, the UE synchronizes to a cell operated in the selected frequency channel, and thereby derives PLMN of the cell (cell PLMN) by reading system information broadcasted by the cell. By obtaining the cell PLMN, the UE knows the visited country with the MCC of the cell PLMN, and then enters the MCC check procedure.

Note that, the abovementioned visited country may be a UE located country, or defined as countries within a coverage range, namely the effective neighborhood (called the neighbors of the visited country). The effective neighborhood is restricted to be equal or larger than the coverage area that any signal transmitted with the maximum power within the area can be received by the UE with an acceptable signal level. Moreover, there may be more than one PLMN provided in the visited country (i.e. MCC), whereas each of the PLMNs contains a single MCC and a unique Mobile Network Code (MNC).

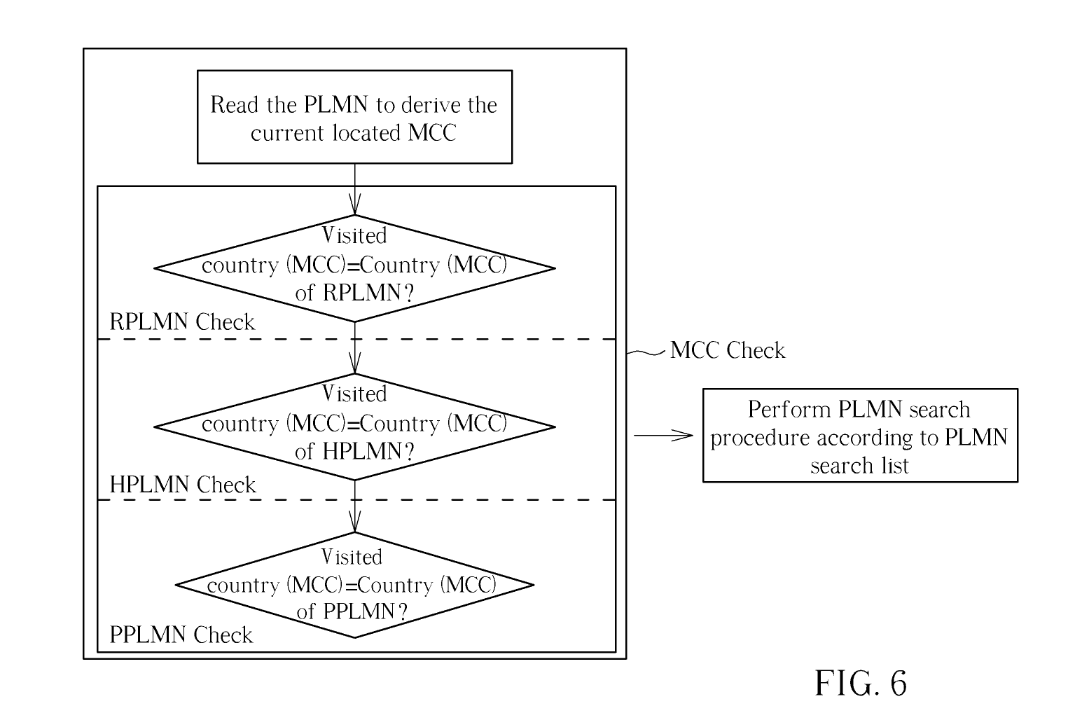

In addition, please refer to FIG. 6, which is a flowchart diagram of the MCC check procedure. The MCC check procedure includes RPLMN, HPLMN and PPLMN check. The UE goes over the RPLMN, HPLMN and PPLMN check sequentially or concurrently. The UE determines whether the visited country (hereafter called MCC) is the same as MCC of RPLMN in PLMN search list stored in the UE. If the MCC is not the same as the MCC of RPLMN, the RPLMN in PLMN search list is assigned with a remove indicator. Similarly, the UE determines whether the MCC is the same as MCC of HPLMN and PPLMN. If the MCC is not the same as the MCC of the HPLMN (or equivalent HPLMN) and PPLMN, the UE assigns the HPLMN and PPLMN with remove indicators. After the UE finishes the MCC check, the UE performs the PLMN search according to the PLMN search list with exception that the PLMNs (namely the RPLMN, HPLMN, and PPLMN) with remove indicator assigned in MCC check step is removed from the PLMN search list. In other words, the UE does not perform the PLMN search over the PLMNs with remove indicators during the PLMN search procedure. Or, the PLMNs with remove indicator will only be searched with a probability less or equal than one during the PLMN search procedure. Therefore, unnecessary PLMN search is avoided, so as to fasten the PLMN search in an international roaming.

Note that, in an embodiment, the UE may perform the MCC check only for RPLMN and HPLMN. In other embodiments, the UE may perform a location derivation procedure when it is switched on (i.e. power up or flight mode off, or come back from no service area), so as to derive the MCC. More specifically, the UE derives its location information based on global positioning system or any cell based positioning system, and thereby deriving the MCC. Note that, the UE may refer to a MCC mapping table between the location information and the MCC. In addition, the UE may get the MCC mapping table via over-the-air (OTA) update method or via the offline update method. After derive the MCC, the UE performs the abovementioned MCC check procedure, and then performs the PLMN search according to the PLMN search list with the remove indicator. The detailed description can be referred from above, so it is omitted herein.

As can be seen, the process 30 clearly specifies that the UE performs MCC check before performing the PLMN search according to the PLMN search list. The MCC check is to validate if a PLMN can be removed from the PLMN searching list. If the PLMN is assigned with a remove indicator, the UE does not search the PLMN during the PLMN search procedure, thereby reducing the PLMN search latency. On the other hand, the UE can directly enter any PLMN search in the PLMN search list with received signal quality, so as to fasten the PLMN search.

Please note that, the abovementioned steps of the processes including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

In conclusion, the exemplary examples and means are provided for enhancing PLMN search for the UE, so as to reduce latency due to unnecessary PLMN search.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of enhancing public land mobile network (PLMN) search for a mobile device in a wireless communication system, the method comprising:
deriving a mobile country code (MCC) for identifying a visited country when the mobile device is switched on, powered up, into flight mode off, or coming back from no service area; and
performing the PLMN search excluding for at least a PLMN, whose MCC is not the same as the derived MCC, according to a PLMN search list stored in the mobile device.

2. The method of claim 1, wherein deriving the MCC for identifying the visited country when the mobile device is switched on after the mobile device is switched on, powered up, into flight mode off, or coming back from no service area comprises:
deriving the MCC from a PLMN derived by reading system information broadcasted by a cell synchronized to the mobile device, or according to location information acquired based on a global positioning system or any cell based positioning system, after the mobile device is switched on after the mobile device is switched on, powered up, into flight mode off, or coming back from no service area.

3. The method of claim 2, wherein the cell is operated in a frequency channel selected by the mobile device whereby a signal level received on the frequency channel is larger than a threshold.

4. The method of claim 3, wherein the frequency channel is acquired by the mobile device scanning over a range of frequency based on at least a radio access technology (RAT) supported by the mobile device.

5. The method of claim 1, wherein the visited country is a country that the mobile device currently located or neighbors of the visited country within a coverage range.

6. The method of claim 1, further comprising:
determining whether the derived MCC is the same as the MCC of a register PLMN (RPLMN) or home PLMN (HPLMN) in the PLMN search list;
assigning a first remove indicator to the RPLMN of the PLMN search list when determining that the derived MCC is not the same as the MCC of the RPLMN; and
assigning a second remove indicator to the HPLMN of the PLMN search list when determining that the derived MCC is not the same as the MCC of the HPLMN, wherein the HPLMN including HPLMN and equivalent HPLMN (EHPLMN).

7. The method of claim 6, wherein performing the PLMN search excluding for at least a PLMN whose MCC is not the same as the derived MCC, according to the PLMN search list stored in the mobile device comprises:
performing no PLMN search for the RPLMN when the RPLMN is assigned with the first remove indicator; and
performing no PLMN search for the HPLMN when the HPLMN is assigned with the second remove indicator.

8. The method of claim 1, further comprising:
determining whether the derived MCC is the same as the MCC of a register PLMN (RPLMN), home PLMN (HPLMN), or prefer PLMN (PPLMN) in the PLMN search list;
assigning a first remove indicator to the RPLMN of the PLMN search list when determining that the derived MCC is not the same as the MCC of the RPLMN;
assigning a second remove indicator to the HPLMN of the PLMN search list when determining that the derived MCC is not the same as the MCC of the HPLMN, wherein the HPLMN including HPLMN and equivalent HPLMN (EHPLMN); and
assigning a third remove indicator to the PPLMN of the PLMN search list when determining that the derived MCC is not the same as the MCC of the PPLMN.

9. The method of claim 8, wherein performing the PLMN search excluding for at least a PLMN whose MCC is not the same as the derived MCC, according to the PLMN search list stored in the mobile device comprises:
performing no PLMN search for the RPLMN when the RPLMN is assigned with the first remove indicator;
performing no PLMN search for the HPLMN when the HPLMN is assigned with the second remove indicator; and
performing no PLMN search for the PPLMN when the PPLMN is assigned with the third remove indicator.

10. The method of claim 9, further comprising:
performing the PLMN search for any PLMN with received signal quality.

11. A mobile device of a wireless communication system for enhancing public land mobile network (PLMN) search, the mobile device comprising:
means for deriving a mobile country code (MCC) for identifying a visited country when the mobile device is switched on, powered up, into flight mode off, or coming back from no service area; and
means for performing the PLMN search excluding for at least a PLMN, whose MCC is not the same as the derived MCC, according to a PLMN search list stored in the mobile device.

12. The mobile device of claim 11, wherein the means for deriving the MCC for identifying the visited country when the mobile device is switched on, powered up, into flight mode off, or coming back from no service area comprises:
means for deriving the MCC from a PLMN derived by reading system information broadcasted by a cell synchronized to the mobile device, or according to location information acquired based on a global positioning system or any cell based positioning system.

13. The mobile device of claim 12, wherein the cell is operated in a frequency channel selected by the mobile device whereby a signal level received on the frequency channel is larger than a threshold.

14. The mobile device of claim 13, wherein the frequency channel is acquired by the mobile device scanning over a range of frequency based on at least a radio access technology (RAT) supported by the mobile device.

15. The mobile device of claim 11, wherein the visited country is a country that the mobile device currently located or neighbors of the visited country within a coverage range.

16. The mobile device of claim 11, further comprising:
means for determining whether the derived MCC is the same as the MCC of a register PLMN (RPLMN) or home PLMN (HPLMN) in the PLMN search list;
means for assigning a first remove indicator to the RPLMN of the PLMN search list when determining that the derived MCC is not the same as the MCC of the RPLMN; and
means for assigning a second remove indicator to the HPLMN of the PLMN search list when determining that the derived MCC is not the same as the MCC of the HPLMN, wherein the HPLMN including HPLMN and equivalent HPLMN (EHPLMN).

17. The mobile device of claim 16, wherein the means for performing the PLMN search excluding for at least a PLMN whose MCC is not the same as the derived MCC, according to the PLMN search list stored in the mobile device comprises:
means for performing no PLMN search for the RPLMN when the RPLMN is assigned with the first remove indicator; and
means for performing no PLMN search for the HPLMN when the HPLMN is assigned with the second remove indicator.

18. The mobile device of claim 11, further comprising:
means for determining whether the derived MCC is the same as the MCC of a register PLMN (RPLMN), home PLMN (HPLMN), or prefer PLMN (PPLMN) in the PLMN search list;
means for assigning a first remove indicator to the RPLMN of the PLMN search list when determining that the derived MCC is not the same as the MCC of the RPLMN;
means for assigning a second remove indicator to the HPLMN of the PLMN search list when determining that the derived MCC is not the same as the MCC of the HPLMN, wherein the HPLMN including HPLMN and equivalent HPLMN (EHPLMN); and
means for assigning a third remove indicator to the PPLMN of the PLMN search list when determining that the derived MCC is not the same as the MCC of the PPLMN.

19. The mobile device of claim 18, wherein the means for performing the PLMN search excluding for at least a PLMN whose MCC is not the same as the derived MCC, according to the PLMN search list stored in the mobile device comprises:
means for performing no PLMN search for the RPLMN when the RPLMN is assigned with the first remove indicator;
means for performing no PLMN search for the HPLMN when the HPLMN is assigned with the second remove indicator; and
means for performing no PLMN search for the PPLMN when the PPLMN is assigned with the third remove indicator.

20. The mobile device of claim 19, further comprising:
means for performing the PLMN search for any PLMN with received signal quality.
